(19) United States
(12) Patent Application Publication
(10) Pub. No.: US 2010/0329792 A1
(43) Pub. Date: Dec. 30, 2010

(54) Controlled bending of pipeline by external force

(76) Inventor: Tor Persson, Houston, TX (US)

Correspondence Address: EGBERT LAW OFFICES, 412 MAIN STREET, 7TH FLOOR, HOUSTON, TX, 77002, US

(21) Appl. No.: 12/456,896

(22) Filed: Jun. 24, 2009

(51) Int. Cl. F16L 1/12

(52) U.S. Cl. 405/168.1

(57) ABSTRACT

Controlled bending of a pipeline laying on the sea floor is achieved by attaching a bending sleeve assembly to a selected bending zone of the pipeline for limiting the controlled bending of the pipeline to a predetermined resulting bending configuration. External force is then applied on the bending sleeve assembly, bending the pipeline to the predetermined resulting bending configuration in cooperation with the bending sleeve assembly and the sea floor. External force can be exerted from one or more weights placed on top of the bending sleeve assembly. External force can be exerted from a winch attached to a wire, the wire passing through a pulley attached to a fixed structure, and the wire attached to the bending sleeve assembly. External force can be exerted through the bending sleeve assembly's contact reaction with an immobile object.

### CROSS-REFERENCE TO RELATED APPLICATIONS

Not applicable.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### INCORPORATION BY REFERENCE OF MATERIAL SUBMITTED ON A COMPACT DISC

Not applicable

### BACKGROUND OF THE INVENTION

1. Field of the Invention

The invention generally relates to methods of controlled bending of a pipeline during the laying thereof in the sea. Specifically, the invented methods utilize external forces to produce controlled bending of a pipeline with aide of a bending sleeve attached to the pipeline.

2. Background of the Invention

Unless otherwise indicated herein, the approaches described in this section are not prior art to the claims in this application and are not admitted to be prior art by inclusion in this section.

Steel pipelines to be laid on the bottom of the sea cannot be pre-formed or pre-adapted to the contour of the sea floor. This is because of the laying or installation procedure that must be used.

There may be tolerated a certain degree of unevenness over which the pipeline is capable of spanning or bending, provided the specific load does not produce excessively high stresses in the pipeline steel. If stresses exceed allowable limits, the pipeline could be deformed permanently, either by buckling or cold bending, or both to an unacceptable configuration. Should cold bending occur through yielding of the steel in the pipeline, it could propagate uncontrollably. Requirements set by classification societies for construction and operation of offshore pipelines permit a certain degree of cold bending provided that it takes place under controlled conditions. Parameters for such controlled conditions entail that a pipeline may be cold bent to a minimum radius lesser than what is allowed for uncontrolled bending.

Pipelines to be laid on an uneven sea floor are subjected to free spanning because of the rigidity of the pipeline. Specifications used for submarine pipeline installation permit plastic deformation as long as positive measures are taken to ensure that excessive bending is prevented. By allowing plastic deformation, it is possible to reduce to a considerable degree the occurrence of free spanning. Bending beyond elastic limits may be achieved by overloading the pipeline by increasing the weight.

Submarine pipelines having a diameter of more than 12 inches usually require a weight coating to achieve negative buoyancy, which is necessary if the pipeline is to be submerged and also maintain a stable state with respect to the sea current. Plastic deformation of a pipeline having a weight coating of concrete will cause the concrete to crack and break loose.

### PRIOR ART

U.S. Pat. No. 5,192,166 describes a method for controlled bending of a pipeline during the laying thereof in the sea, utilizing bend controlling/stopping means which are mounted on the pipeline as a sleeve and interact with the pipeline. To achieve cold bending under controlled conditions, the pipeline is weight loaded internally at the selected bending zone. The weight loading may be achieved by means of a flexible string of weight elements and/or by introducing into the pipe a suitable heavy, readily flowable weight mass, for example, drilling fluid or water.

### BRIEF SUMMARY OF THE INVENTION

Embodiments of the present invention include methods for controlled bending of a pipeline laying on the sea floor. The term “sea floor” used hereafter refers to the bottom of a body of water. For example, a sea floor can be the bottom of the sea, river, pond, or lake.

In one embodiment of the present invention, a bending sleeve assembly is attached to a selected bending zone of the pipeline for limiting the controlled bending of the pipeline to a predetermined resulting bending configuration. An external force is then applied on the bending sleeve assembly attached to the pipeline. As a result, the external force causes the pipeline to be bent to the predetermined configuration in cooperation with the bending sleeve assembly and the sea floor.

In another embodiment of the present invention, a bending sleeve assembly is attached to a selected bending zone of the pipeline for limiting the controlled bending of the pipeline to a predetermined resulting bending configuration. A pulley is attached to an anchoring point below the bending sleeve assembly. One end of an elongate flexible member is attached to the bending sleeve assembly. The elongate flexible member can be a wire, cable, belt, chain, rope, or strap. The elongate flexible member is passed through the pulley. The other end of the elongate flexible member is attached to a winch mounted on a structure above the bending sleeve assembly. The winch is operated to exert an external force to pull the bending sleeve assembly towards the pulley attached to the structure below the bending sleeve assembly. As a result, the external force bends the pipeline to the predetermined resulting bending configuration in cooperation with the bending sleeve assembly.

In yet another embodiment of the present invention, a bending sleeve assembly is attached to a selected bending zone of the pipeline for limiting the controlled bending of the pipeline to a predetermined resulting bending configuration. The pipeline is installed from a vessel which holds one end of the pipeline. The bending sleeve assembly attached to the pipeline is positioned next to an immobile object. The pipeline is then deviated horizontally around the immobile object. As a result, the bending sleeve assembly makes contact with the immobile object and the reaction from the immobile object exerts an external force that causes the pipeline to bend to the predetermined angular configuration in cooperation with the bending sleeve assembly.

### BRIEF DESCRIPTION OF THE SEVERAL VIEWS OF THE DRAWINGS

FIG. 1A illustrates a bending sleeve assembly attached at one end to a pipeline in one embodiment of the present invention.

FIG. 1B shows a cross-sectional view of the bending sleeve assembly attached at one end to the pipeline in FIG. 1A in one embodiment of the present invention.

FIG. 2 shows a semi-section view of a coupling connection in one embodiment of the present invention.

FIG. 3 shows the use of a weight as an external force to induce bending of a pipeline at the location where a bending sleeve assembly is attached in one embodiment of the present invention.

FIGS. 4A-C show a method of using a weight as an external force to induce bending of a pipeline at a location where a bending sleeve assembly is attached in different directions in one embodiment of the present invention.

FIG. 5 shows the method in FIG. 4 where the wires are attached to winches mounted on a vessel in one embodiment of the present invention.

FIG. 6 shows a method of using a winch mounted on a vessel, a wire, and a pulley to exert an external force to bend a pipeline attached to a bending sleeve assembly in one embodiment of the present invention.

FIG. 7 shows a method of using permanent weights to exert an external force to a bending sleeve assembly attached to a pipeline which induces bending of the pipeline in one embodiment of the present invention.

FIGS. 8A and 8B show a plan view of a method using a vessel and an anchor to bend a pipeline at a section where a bending sleeve assembly is attached to the pipeline in one embodiment of the present invention.

FIGS. 9A and 9B show a plan view of a method using a vessel to install a pipeline around an immobile object where a bending sleeve assembly is attached to the pipeline in one embodiment of the present invention.

Like elements in the various figures are denoted by like reference numerals for consistency.

### DETAILED DESCRIPTION OF THE INVENTION

### Bending Sleeve Assembly

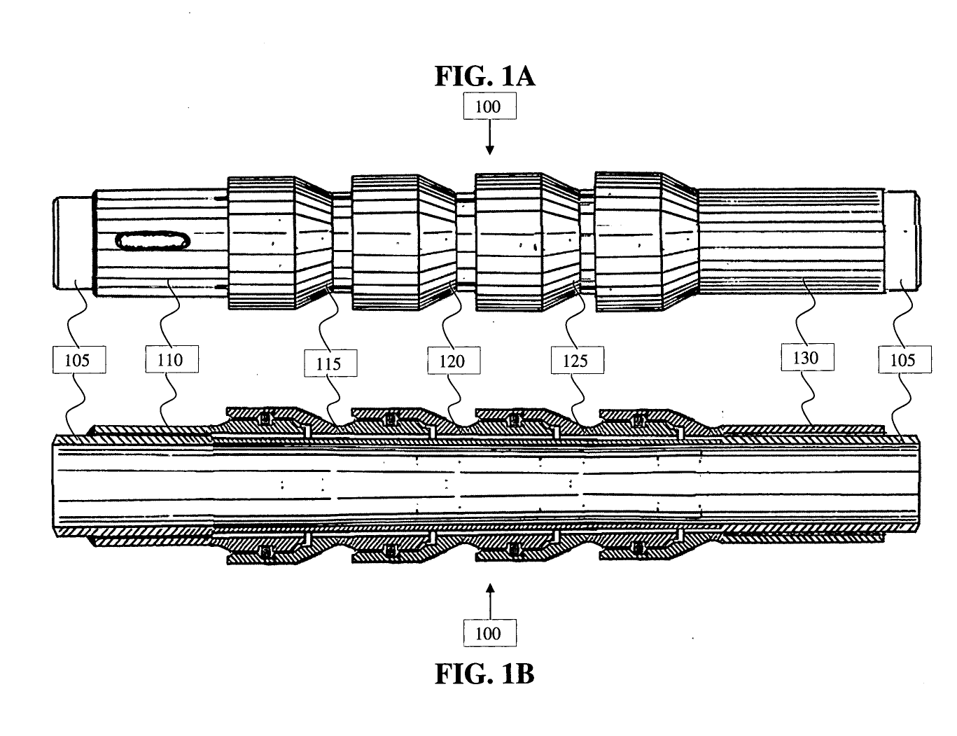

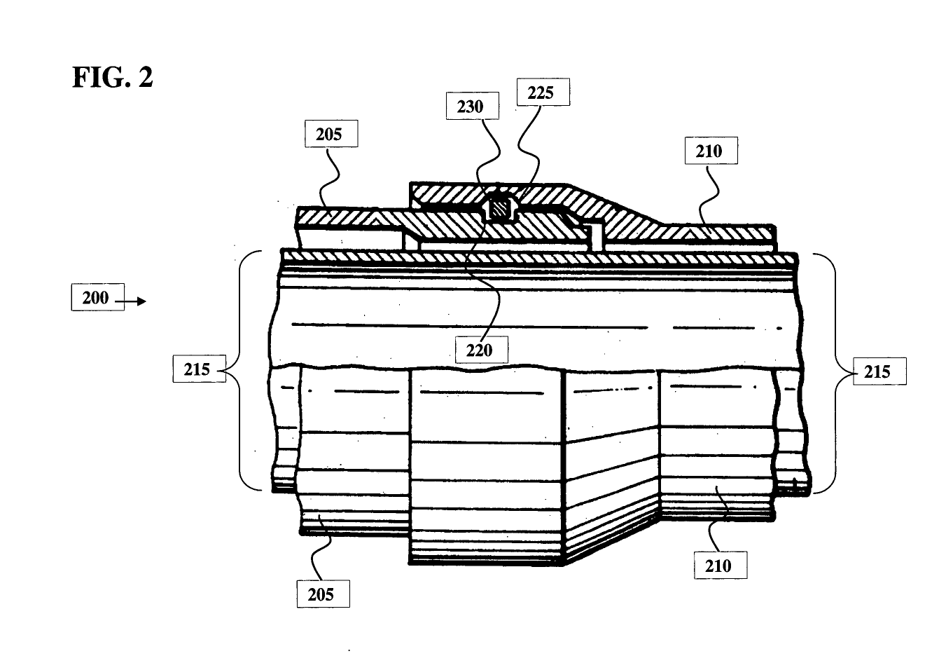

FIG. 1A illustrates a bending sleeve assembly 100 attached at one end to a pipeline 105 in one embodiment of the present invention. As further described below, the other end of the bending sleeve assembly 100 is free to move along the longitudinal axis of pipeline 105 which is required when bending takes place. FIG. 1B shows a cross-sectional view of the bending sleeve assembly 100 attached at one end to the pipeline 105 in FIG. 1A. FIG. 1B shows four coupling connection as an example. Each coupling connection is comprised of a male and a female coupling part, which are locked together in grooves by a steel ring, as further detailed in FIG. 2. The number of coupling connections can be increased to as many as is required by the design for a specific location. Typically, steel pipelines are encased with an external concrete coating when laid on the sea floor. The external concrete coating has been removed from a section of the pipeline 105 where the bending sleeve assembly 100 is positioned. The example bending sleeve assembly 100 is comprised of five pieces coupled together by four couplings connections: a tube sleeve piece welded to a male coupling part 110; three interconnecting pieces with female and male coupling parts 115, 120, and 125; and a tube sleeve welded to a female coupling part 130. Only one of the tube sleeves is attached to the pipeline. In this example, the tube sleeve with the male coupling part 110 is attached by welding to the pipeline 105. The tube sleeve with the female coupling part 130 is free to move along the longitudinal axis of pipeline 105, which is required when bending takes place. The interconnecting pieces 115, 120, and 125 each comprise of a female coupling part welded to a male coupling part. Alternative embodiments of the interconnecting piece can include a tube (also called an “interconnecting tube”) welded between the female and male coupling part—the female coupling part is welded to one end of the tube and the male coupling part is welded to the other end of the tube. The interconnecting tube extends the distance between the female and male coupling part as required to achieve a predetermined resulting bending configuration. A bending sleeve assembly comprises at least one interconnecting piece, and can comprise as many interconnecting pieces as required to achieve the predetermined resulting bending configuration.

FIG. 2 shows a semi-section view of a coupling connection 200 in one embodiment of the present invention. A male coupling part 205 and a female coupling part 210 are assembled on one section of a pipeline 215. The male coupling part 205 is engaged to a female coupling part 210 in an overlapping relationship. The male and female coupling parts 205, 210 have two mutually aligned annular grooves 220, 225 into which a locking ring 230 is inserted. The tolerance between the annular grooves 220, 225 and the locking ring 230 will be a determining factor for the degree of angular deviation that may be accepted by the coupling connection. These angular deviations will also determine the maximal bending to the pipeline 215 extending through the bending sleeve assembly.

### Controlled Bending by External Force

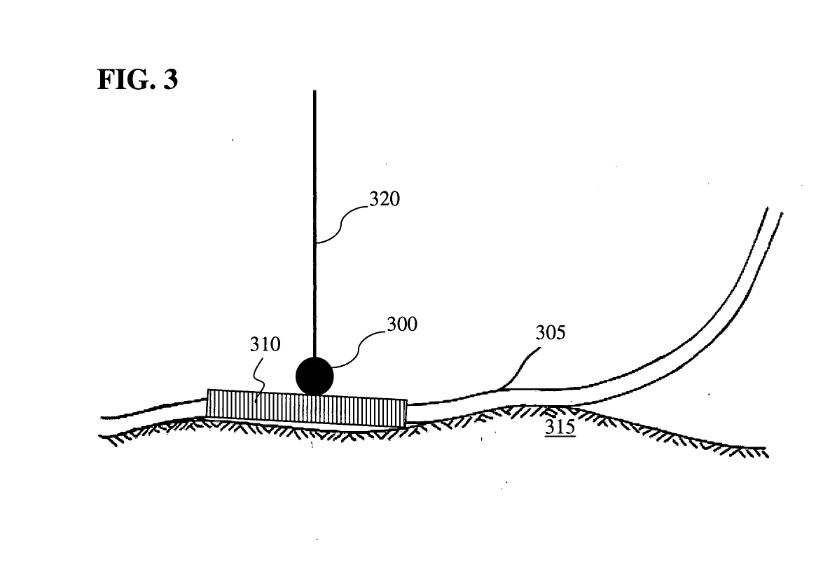

FIG. 3 shows a method of using a weight 300 as an external force to induce bending of a pipeline 305 where a bending sleeve assembly 310 is attached to the pipeline 305 in one embodiment of the present invention. The pipeline 305 is free spanning over the sea floor 315. The weight 300 is placed on top of the bending sleeve assembly 310. The weight 300 is suspended from one or more elongate flexible members such as a wire 320, where one end of the elongate flexible member 320 is attached to the weight 300. Different elongate flexible members, in addition to wires can be used to serve the same purpose. For example, a cable, belt, chain, rope, strap or the like can be used instead of a wire. The weight 300 is positioned on top of the pipeline 305 where the bending sleeve assembly 310 is attached. The weight 300 provides an external force on the bending sleeve assembly 310 and pipeline 305, permanently bending the pipeline 305 to a curvature predefined by the bending sleeve assembly 310. The bending sleeve assembly 310 is designed to absorb the point load forces from the weight 300 and restrict the increase in diameter or flattening as a result of the bending of the pipeline 305.

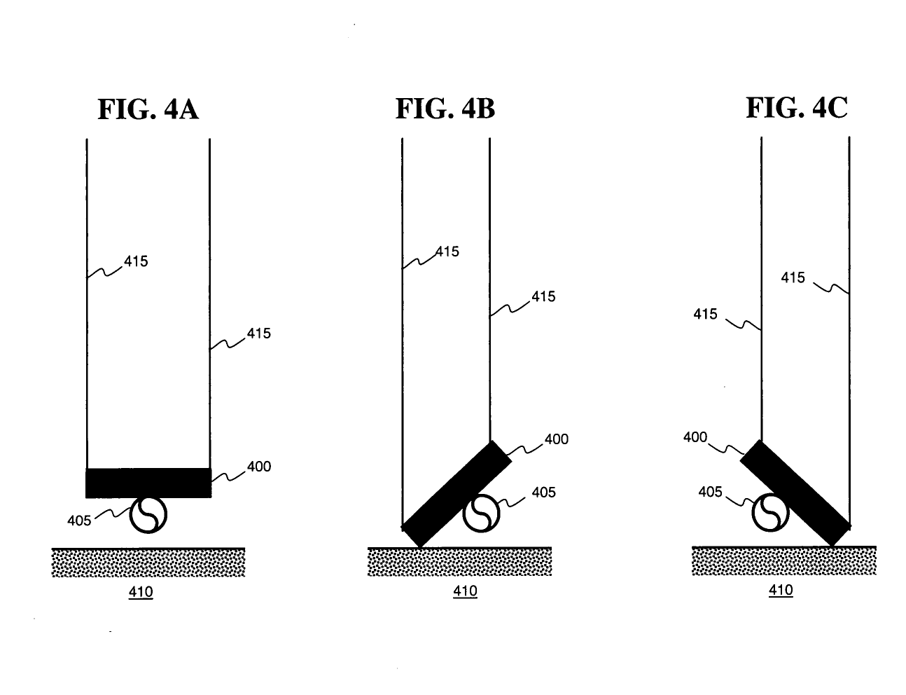

FIGS. 4A-C show a method of using a weight 400 as an external force to induce bending of a pipeline 405 where a bending sleeve assembly is attached (not shown in detail) in different directions in one embodiment of the present invention. The pipeline 405 is free spanning over the sea floor 410. The elongated-shaped weight 400 is held by two (or more) elongate flexible members such as wires 415 attached to opposite ends of the weight 400. Different elongate flexible members, other than wires, can be used to serve the same purpose. For example, cables, belts, chains, ropes, straps or the like can be used instead of wires. The angle of the external force exerted by the weight 400 can be altered by adjusting the length of the wires 415.

The weight 400 can exert an external force on the pipeline 405 in different directions, depending on the bending requirement. FIG. 4A shows the weight 400 exerting an external force in a vertical direction on the bending sleeve assembly attached to the pipeline 405. FIGS. 4B and 4C show one end of the weight 400 resting on the sea floor 410 with the weight 405 exerting an external force in a diagonal direction on the bending sleeve assembly attached to the pipeline 405.

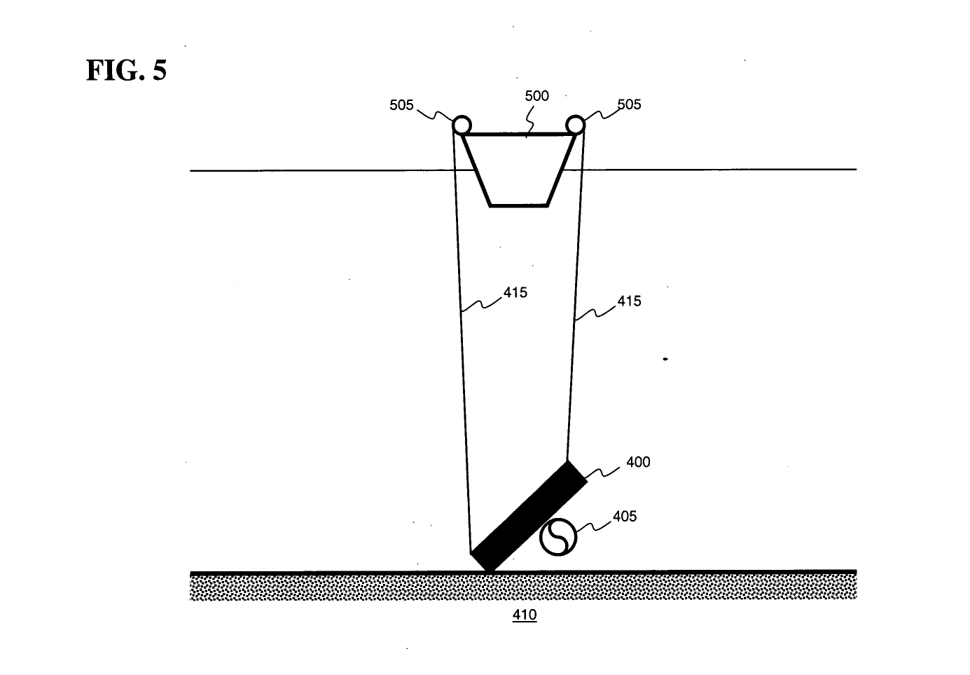

FIG. 5 shows the method in FIG. 4 where the wires 415 are attached to winches 505 mounted on a vessel 500 in one embodiment of the invention. The winches 505 are operated to control the angle of the external force exerted by the weight 400 on the bending sleeve assembly attached to the pipeline 405 by adjusting the lengths of the wires 415. Remotely operated underwater vehicles (ROVs) with video cameras and other subsea surveying equipment commonly known in the industry may be used to guide the position of the weight 400 at the desired location.

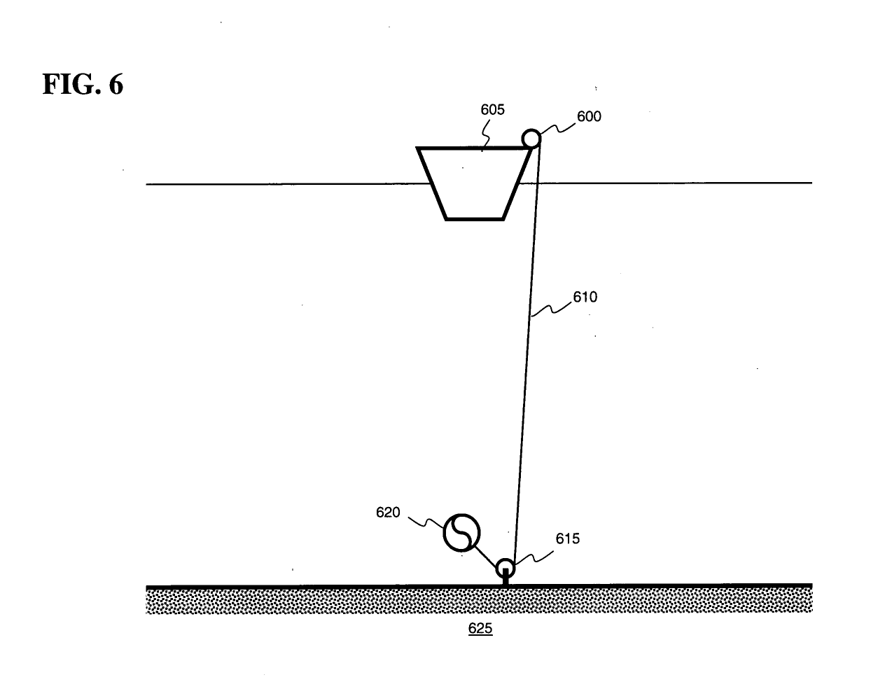

FIG. 6 shows a method of using a winch 600 mounted on a vessel 605, a wire 610, and a pulley 615 to exert an external force to bend a pipeline 620 attached to a bending sleeve assembly (not shown) in one embodiment of the present invention. One end of the wire 610 is attached to the winch 600 mounted on the vessel 605 positioned above the bending sleeve assembly. The wire 610 runs from the winch 600 through the pulley 615 secured to the sea floor 625 below the bending sleeve assembly. The other end of the wire 610 is attached to the pipeline 620 where the bending sleeve assembly (not shown) is attached. A different elongate flexible member, other than a wire, can be used to serve the same purpose. For example, a cable belt, chain, rope, strap or the like can be used instead of a wire. When the winch 600 is activated to pull the wire 610, the pulley 615 directs the wire 610 to exert an external force on the pipeline 620, bending the pipeline 620 towards the pulley 615.

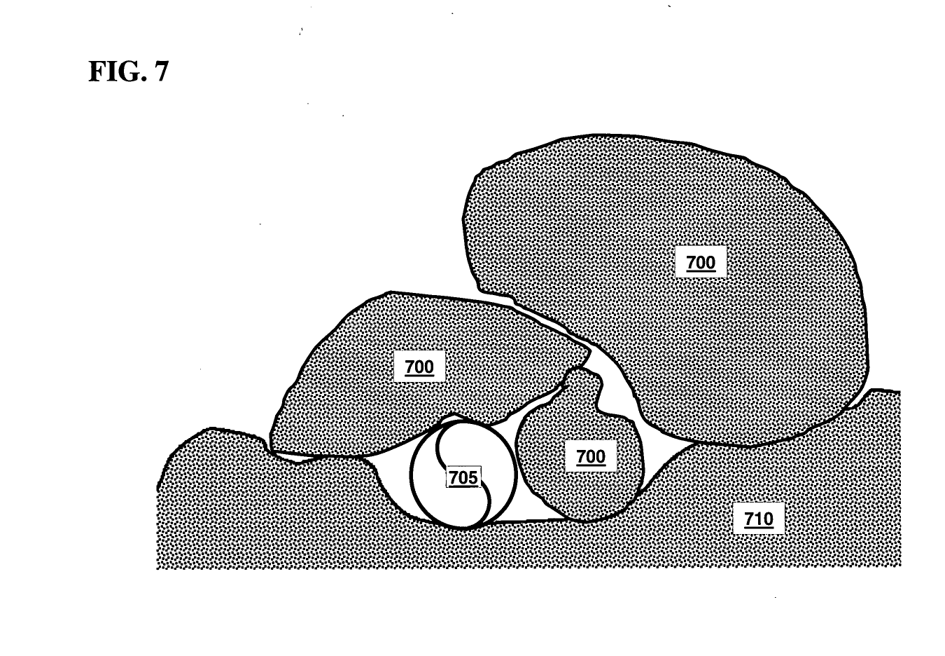

FIG. 7 shows a method of using permanent weights 700 to exert an external force to a bending sleeve assembly (not shown) attached to a pipeline 705 which induces bending of the pipeline in one embodiment of the present invention. Weights 700 are placed on top of and around the pipeline 705 at a section of the pipeline 705 where the bending sleeve assembly (not shown) is attached. The bending sleeve assembly is designed to be sufficiently strong to accept permanent external forces exerted by the weights 700 and possible forces from ice and actions from the sea. The weights 700 can be made of natural material such as large rocks or of manufactured components (man-made material). The weights 700 are permanently placed at specific locations to bend the pipeline 705 to an acceptable bending radius to conform to the seabed. This approach also provides physical protection for the pipeline 705 from other external forces such as ice, wave actions and sea currents. This embodiment is particularly useful at locations where pipelines are laid on sea floor where rock formations are present.

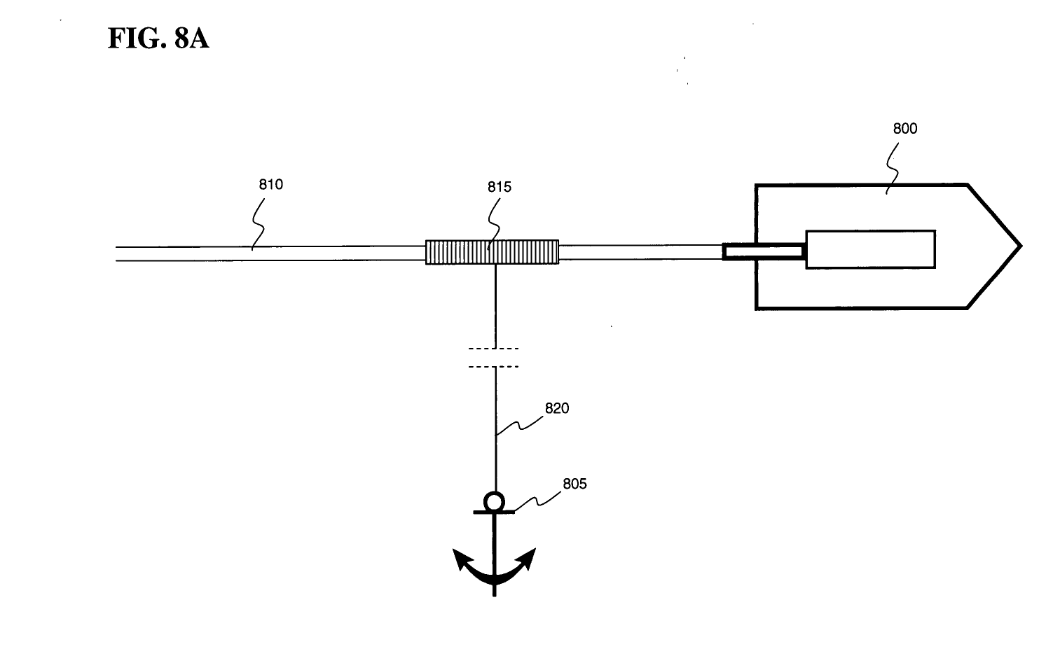

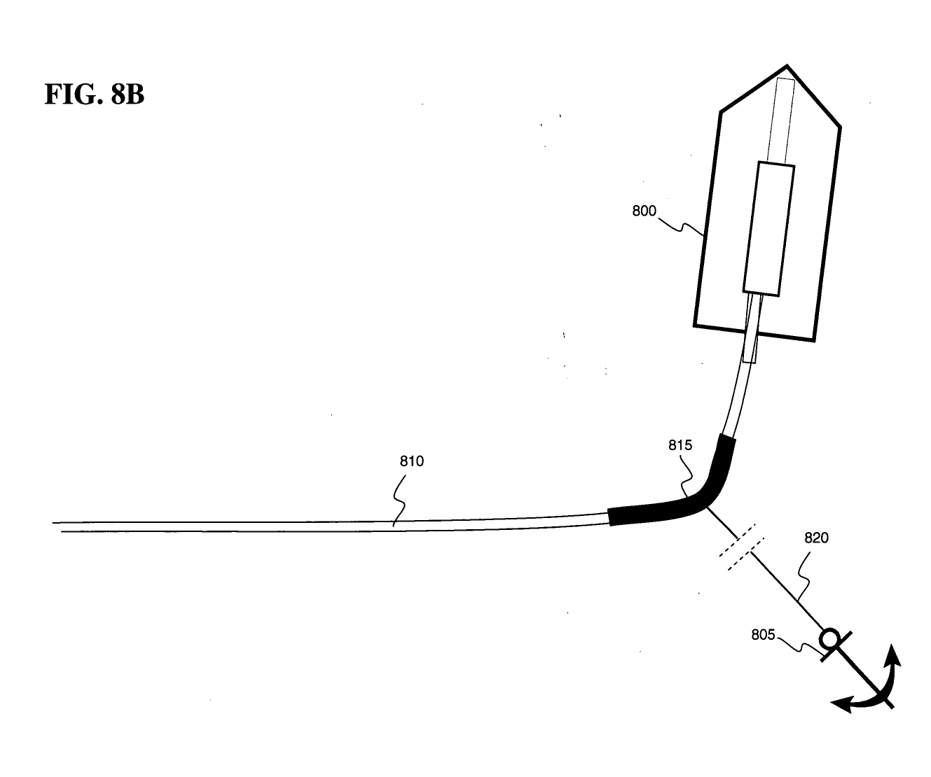

FIGS. 8A and 8B show a plan view of a method using a vessel 800 and an anchor 805 to bend a pipeline 810 at a section where a bending sleeve assembly 815 is attached to the pipeline 810 in one embodiment of the present invention. The vessel 800 installs the pipeline 810 on the sea floor. The bending sleeve assembly 815 attached to the pipeline 810 is positioned on the pipeline 810 at a section where bending is desired. One end of a wire 820 is attached to the pipeline 810 where the bending sleeve assembly 815 is attached. The other end of the wire 820 is attached to an anchor 805 resting on the sea floor. Alternatively, the other end of the wire 820 can be attached to an immobile object, a vessel, or the sea floor itself. A different elongate flexible member, other than a wire, can be used to serve the same purpose. For example, a cable belt, chain, rope, strap or the like can be used instead of a wire. The vessel 800, holding one end of the pipeline 810, turns in a direction deviating horizontally away from the anchor 805. As a result, the anchor 805 exerts an external force on the bending sleeve assembly 815 attached to the pipeline 810, bending the pipeline 810 in the direction of the vessel 800. FIG. 8A shows the pipeline 810 before controlled bending. FIG. 8B shows the pipeline 810 after controlled bending.

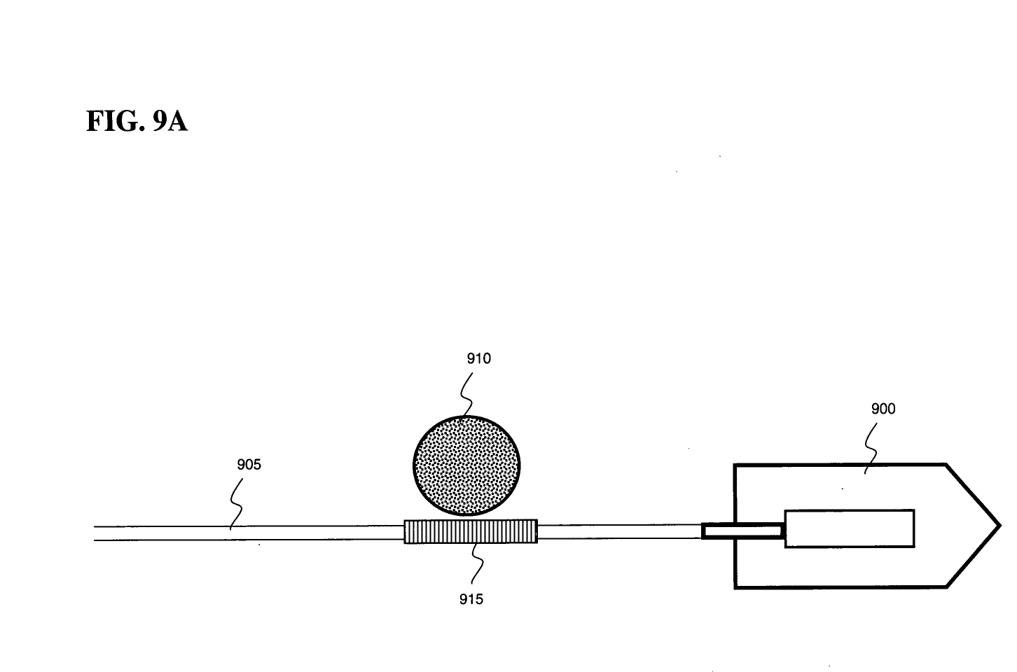

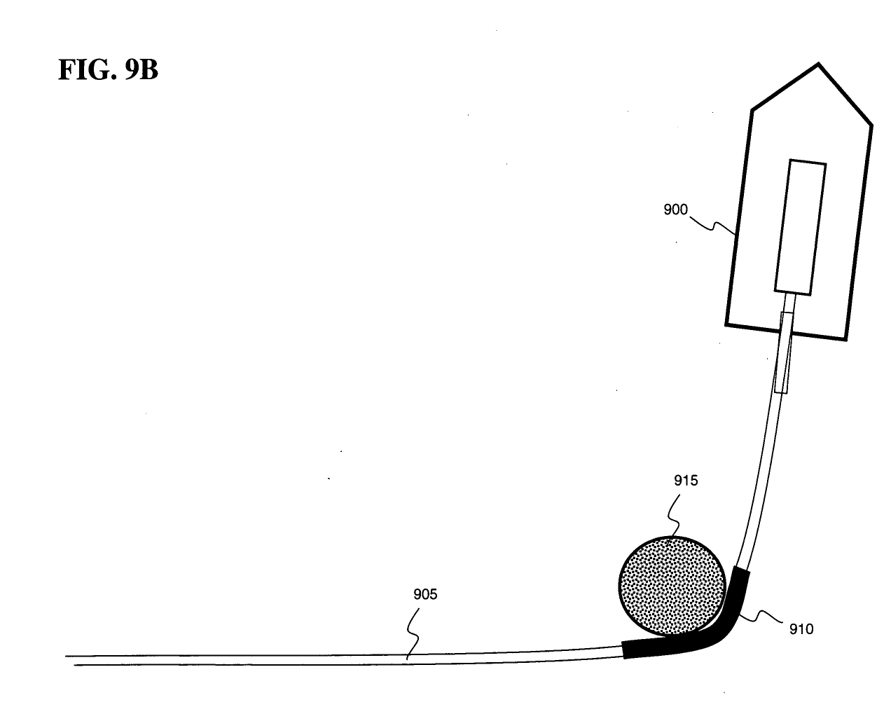

FIGS. 9A and 9B show a plan view of a method using a vessel 900 to install a pipeline 905 around an immobile object 910 where a bending sleeve assembly 915 is attached to the pipeline 905 in one embodiment of the present invention. The vessel 900 lays down the pipeline 905 around the immobile object 910. The bending sleeve assembly 915 attached to the pipeline 905 is positioned next to the immobile object 910. The vessel 900, holding one end of the pipeline 905, turns in a direction deviating horizontally around the immobile object 910. As a result, the bending sleeve assembly 915 makes contact with the immobile object 910 and the reaction from the immobile object 910 exerts an external force on the bending sleeve assembly 915 attached to the pipeline 905, bending the pipeline 905 around the immobile object 910. FIG. 9A shows the pipeline 905 before controlled bending. FIG. 9B shows the pipeline 905 after controlled bending.

Controlled Bending by External Force in Combination with Internally Loaded Weight

Alternative embodiments of the present invention can include using the invented methods for controlled bending by external force in combination with prior art methods for controlled bending; for example, internally loading weights in the pipeline to exert a force on the selected bending zone of the pipeline.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention. Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims.

I claim:

1. A method for controlled bending of a pipeline laying on the sea floor, the method comprising:
attaching a bending sleeve assembly to a selected bending zone of the pipeline for limiting the controlled bending of the pipeline to a predetermined resulting bending configuration, and
applying an external force on the bending sleeve assembly attached to the pipeline;
whereby the external force causes the pipeline to be bent to the predetermined resulting configuration in cooperation with the bending sleeve assembly and the sea floor.

2. The method according to claim 1, wherein the bending sleeve assembly comprises:
a first tube sleeve piece comprising a first tube attached to a coupling part, at least one interconnecting piece comprising a female coupling part and a male coupling part, and
a second tube sleeve piece comprising a second tube attached to a coupling part;
wherein:
the first tube sleeve piece is attached to the pipeline,
one interconnecting piece forms a coupling connection with the first tube sleeve piece,
the second tube sleeve piece forms a coupling connection with one interconnecting piece, and
wherein the coupling connection comprises a male coupling part engaged to a female coupling part in overlapping relationship by a lock ring disposed in two aligned annular grooves in the coupling parts.

3. The method according to claim 2, wherein the interconnecting piece further comprises an interconnecting tube, wherein the female coupling part is attached to one end of the interconnecting tube and the male coupling part is attached to the other end of the interconnecting tube.

4. The method according to claim 1, wherein the step of applying an external force on the bending sleeve assembly comprises placing a weight on top of the bending sleeve assembly; wherein the weight is suspended by at least one elongate flexible member, wherein one end of the elongate flexible member is attached to the weight, and the elongate flexible member is selected from the group consisting of a wire, cable, belt, chain, rope, and strap.

5. The method according to claim 4, wherein the weight is a elongated-shaped weight suspended by two elongate flexible members, wherein one end of each elongate flexible member is attached to an opposite end of the elongated-shaped weight and the other end of each elongate flexible member is attached to a winch, whereby the two winches are operable to control the length of the elongate flexible member and thus the angle of the external force exerted by the rod-shaped weight.

6. The method according to claim 5, wherein the winches are mounted on a vessel.

7. The method according to claim 1, wherein the step of applying an external force on the bending sleeve assembly comprises placing at least one weight on top of and around the bending sleeve assembly attached to the pipeline.

8. The method according to claim 7, wherein the weight is selected from the group consisting of natural material and man-made material.

9. The method according to claim 1, further comprising the step of internally loading weights in the pipeline to exert a force on the selected bending zone of the pipeline.

10. A method for controlled bending of a pipeline laying on the sea floor, the method comprising:
attaching a bending sleeve assembly to a selected bending zone of the pipeline for limiting the controlled bending of the pipeline to a predetermined resulting bending configuration;
attaching a pulley to a structure below the bending sleeve assembly;
attaching one end of an elongate flexible member to the bending sleeve assembly, wherein the elongate flexible member is selected from the group consisting of a wire, cable, belt, chain, rope, and strap;
passing the elongate flexible member through the pulley;
attaching the other end of the elongate flexible member to a winch mounted on a structure above the bending sleeve assembly; and
operating the winch to exert an external force to pull the bending sleeve assembly towards the pulley attached to the structure below the bending sleeve assembly;
whereby the external force bends the pipeline to the predetermined resulting bending configuration in cooperation with the bending sleeve assembly.

11. The method according to claim 10, wherein the bending sleeve assembly comprises:
a first tube sleeve piece comprising a first tube attached to a coupling part,
at least one interconnecting piece comprising a female coupling part and a male coupling part, and
a second tube sleeve piece comprising a second tube attached to a coupling part;
wherein:
the first tube sleeve piece is attached to the pipeline,
one interconnecting piece forms a coupling connection with the first tube sleeve piece,
the second tube sleeve piece forms a coupling connection with one interconnecting piece, and
wherein the coupling connection comprises a male coupling part engaged to a female coupling part in overlapping relationship by a lock ring disposed in two aligned annular grooves in the coupling parts.

12. The method according to claim 11, wherein the interconnecting piece further comprises an interconnecting tube, wherein the female coupling part is attached to one end of the interconnecting tube and the male coupling part is attached to the other end of the interconnecting tube.

13. The method according to claim 10, wherein the structure below the bending sleeve assembly is the sea floor and the structure above the bending sleeve assembly is a vessel.

14. The method according to claim 10, further comprising the step of internally loading weights in the pipeline to exert a force on the selected bending zone of the pipeline.

15. A method for controlled bending of a pipeline laying on the sea floor, the method comprising:
attaching a bending sleeve assembly to a selected bending zone of the pipeline for limiting the controlled bending of the pipeline to a predetermined resulting bending configuration;
laying the pipeline from a vessel, wherein the vessel holds one end of the pipeline;
attaching one end of an elongate flexible member to the bending sleeve assembly, wherein the elongate flexible member is selected from the group consisting of a wire, cable, belt, chain, rope, and strap;
attaching the other end of the elongate flexible member to an immobile object, wherein the immobile object is selected from the group consisting of an anchor, vessel, and the sea floor;
deviating the pipeline horizontally away from the immobile object;
whereby the immobile object exerts an external force on the bending sleeve assembly attached to the pipeline, bending the pipeline to the predetermined angular configuration in cooperation with the bending sleeve assembly.

16. The method according to claim 15, wherein the bending sleeve assembly comprises:
a first tube sleeve piece comprising a first tube attached to a coupling part,
at least one interconnecting piece comprising a female coupling part and a male coupling part, and
a second tube sleeve piece comprising a second tube attached to a coupling part;
wherein:
the first tube sleeve piece is attached to the pipeline,
one interconnecting piece forms a coupling connection with the first tube sleeve piece,
the second tube sleeve piece forms a coupling connection with one interconnecting piece, and
wherein the coupling connection comprises a male coupling part engaged to a female coupling part in overlapping relationship by a lock ring disposed in two aligned annular grooves in the coupling parts.

17. The method according to claim 16, wherein the interconnecting piece further comprises an interconnecting tube, wherein the female coupling part is attached to one end of the interconnecting tube and the male coupling part is attached to the other end of the interconnecting tube.

18. A method for controlled bending of a pipeline laying on the sea floor, the method comprising:
attaching a bending sleeve assembly to a selected bending zone of the pipeline for limiting the controlled bending of the pipeline to a predetermined resulting bending configuration;
laying the pipeline from a vessel, wherein the vessel holds one end of the pipeline;
positioning the bending sleeve assembly attached to the pipeline next to an immobile object;
deviating the pipeline horizontally around the immobile object;
whereby the bending sleeve assembly makes contact with the immobile object and the reaction from the immobile object exerts an external force to bend the pipeline to the predetermined angular configuration in cooperation with the bending sleeve assembly.

19. The method according to claim 18, wherein the bending sleeve assembly comprises:
a first tube sleeve piece comprising a first tube attached to a coupling part,
at least one interconnecting piece comprising a female coupling part and a male coupling part, and
a second tube sleeve piece comprising a second tube attached to a coupling part;
wherein:
the first tube sleeve piece is attached to the pipeline,
one interconnecting piece forms a coupling connection with the first tube sleeve piece,
the second tube sleeve piece forms a coupling connection with one interconnecting piece, and
wherein the coupling connection comprises a male coupling part engaged to a female coupling part in overlapping relationship by a lock ring disposed in two aligned annular grooves in the coupling parts.

20. The method according to claim 19, wherein the interconnecting piece further comprises an interconnecting tube, wherein the female coupling part is attached to one end of the interconnecting tube and the male coupling part is attached to the other end of the interconnecting tube.
